(19) United States
(12) Patent Application Publication
(10) Pub. No.: US 2009/0003769 A1
(43) Pub. Date: Jan. 1, 2009

(54) OPTICAL ISOLATOR

(76) Inventors: Yasuo FUKAI, Osaka (JP); Toshiyuki Okumura, Tenri-shi (JP)

Correspondence Address: BIRCH STEWART KOLASCH & BIRCH, PO BOX 747, FALLS CHURCH, VA, 22040-0747, US

(21) Appl. No.: 12/126,786

(22) Filed: May 23, 2008

(30) Foreign Application Priority Data
Jun. 27, 2007 (JP) 2007-169068(P)

(51) Int. Cl. G02B 6/26; G02B 6/12

(52) U.S. Cl. 385/42; 385/14

(57) ABSTRACT

On a surface of an Si layer of a substrate, a plurality of optical waveguides are formed that extend linearly in the Y-axis direction and that are separated from each other by a predetermined spacing in the X-axis direction. These optical waveguides each have a width that monotonously increases in the X-axis direction such that an amount of change of the equivalent refractive index of optical waveguides per unit length is constant in the X-axis direction. In this way, an optical isolator is obtained that can operate for an input light in any state of polarization and that can remove a returned light in any state of polarization without allowing the light to return to an input portion.

This nonprovisional application is based on Japanese Patent Application No. 2007-169068 filed with the Japan Patent Office on Jun. 27, 2007, the entire contents of which are hereby incorporated by reference.

### BACKGROUND OF THE INVENTION

1. Field of the Invention

The present invention relates to an optical isolator, and particularly to an optical isolator using optical Bloch oscillations.

2. Description of the Background Art

A semiconductor laser has been used as a light source for an optical communication system or optical information processing system for example. The light emitted from the semiconductor laser is transmitted through another optical device. However, a part of the light emitted from the semiconductor laser is returned to the semiconductor laser due to influences for example of reflection and scattering occurring when the light passes through the optical device. Since the semiconductor laser is influenced by the light which is returned (returned light), the lasing characteristic of the semiconductor laser is deteriorated. In order to solve this problem, an optical isolator is currently used.

The optical isolator has the characteristic of preventing transmission from an output port to an input port of the optical isolator. Specifically, while the light entering the input port of the optical isolator is output from the output port, the light entering the output port is not output from the input port. Therefore, an output of the semiconductor laser and the input port of the optical isolator are connected to prevent the lasing characteristic of the semiconductor laser from being deteriorated due to the returned light.

Currently, a bulk optical isolator which is one type of the optical isolator is commercially practical. The bulk optical isolator, however, does not have the function of trapping the light in a cross-sectional layer which is orthogonal to the direction of propagation of the light, and thus the propagation loss is large. Further, the bulk optical isolator cannot be manufactured integrally with the semiconductor laser. Therefore, the semiconductor laser and the optical isolator are separately fabricated and the semiconductor laser and the optical isolator are assembled in a subsequent process, resulting in the problems that the manufacturing process is complicated and that the manufacturing cost is increased. In order to solve such problems, a patent document (Japanese Patent Laying-Open No. 2003-302603) for example proposes a waveguide optical isolator.

A TM (Transverse Magnetic) mode optical isolator disclosed in the above-referenced patent document is shown in FIGS. 15 and 16. As shown in the drawings, a waveguide optical isolator 300 includes a substrate 301 and a lower cladding layer 302 grown on a surface of substrate 301 and, an input optical waveguide 303, an output optical waveguide 304, an optical waveguide 305 and an optical waveguide 306 that are formed on lower cladding layer 302. Input optical waveguide 303 has an end surface on the outer side of the device, and the end surface is provided with an input port 307. Likewise, output optical waveguide 304 has an end surface on the outer side of the device, and the end surface is provided with an output port 308. The four optical waveguides 303, 304, 305, and 306 are covered with an upper cladding layer 309.

In order to configure a Mach-Zehnder interferometer by disposing optical waveguide 305 and optical waveguide 306 opposite to each other that are arm-shaped and substantially identical in shape, a three-branch optical coupler 310 is disposed on the input port side and a three-branch optical coupler 311 is disposed on the output port side. Optical waveguide 305 and optical waveguide 306 located in the region between three-branch optical couplers 310 and 311 are used to configure the interferometer.

In order to generate a phase difference between two waves propagating through the interferometer, nonreciprocal phase shifters 312 are incorporated to optical waveguide 305 and optical waveguide 306. For nonreciprocal phase shifters 312, a rare-earth magnetic garnet which is a magnetic material represented by the composition formula R₃Fe₅O₁₂ (R represents a rare-earth element) is used. As an external magnetic field 313 is applied to nonreciprocal phase shifter 312, a photomagnetic effect of the light propagating through nonreciprocal phase shifter 312 is obtained.

The action of the photomagnetic effect varies depending on the direction of the vector of a magnetic-field component of propagating light with respect to the magnetization direction of the magnetic material. Therefore, as shown in FIG. 15, the direction of external magnetic field 313 applied to nonreciprocal phase shifter 312 on optical waveguide 305 and that on optical waveguide 306 are made opposite to each other and the magnitude of the magnetic field is adjusted. Thus, a nonreciprocal phase difference of −π/2 can be obtained between the two TM mode light waves propagating in the forward direction through nonreciprocal phase shifters 312. In contrast, a nonreciprocal phase difference π/2 can be obtained between the two TM mode light waves propagating in the reverse direction through nonreciprocal phase shifters 312. Regarding two TE (Transverse Electric) mode light waves propagating in the forward or reverse direction through nonreciprocal phase shifters 312, no phase difference is obtained. Here, “forward direction” refers to the direction from input port 307 side to output port 308 side, and “reverse direction” refers to the direction from output port 308 side to input port 307 side.

Moreover, in order to provide a reciprocal phase difference between the two waves propagating through the interferometer, a reciprocal phase shifter 314 is incorporated to optical waveguide 305. Reciprocal phase shifter 314 is made using an optical waveguide having a mode birefringence index. For the TM mode, the length of the reciprocal phase shifter is adjusted to satisfy the condition (¼+m)×π_{TM}. For the TE mode, the length of the reciprocal phase shifter is adjusted to satisfy the condition (½+m)×λ_{TE}. In this way, the reciprocal phase difference π/2 can be obtained between the two TM mode light waves propagating through the interferometer. Further, the reciprocal phase difference π can be obtained between the two TE mode light waves propagating through the interferometer.

An operational principle of optical isolator 300 will be described. The TM mode light entering input port 307 propagates in the forward direction and is decomposed by three-branch optical coupler 310 into two waves of the same amplitude and the same phase. As the two waves propagate through the interferometer, the phase difference between the two waves at nonreciprocal phase shifters 312 is nonreciprocal and −π/2 and the phase difference between the two waves at reciprocal phase shifter 314 of optical waveguide 305 and optical waveguide 306 is reciprocal and π/2. Therefore, when the two waves are coupled at three-branch optical coupler 311, the two waves have the same amplitude and the same phase. Thus, the two waves are coupled at output optical waveguide 304 and the TM mode light is output from output port 308.

In contrast, the TM mode light entering output port 308 propagates in the reverse direction and is decomposed by three-branch optical coupler 311 into two waves of the same amplitude and the same phase. As the two waves propagate through the interferometer, the phase difference between two waves at reciprocal phase shifter 314 of optical waveguide 305 and optical waveguide 306 is reciprocal and π/2 and the phase difference between two waves at nonreciprocal phase shifters 312 is nonreciprocal and π/2. Therefore, when the two waves are coupled at three-branch optical coupler 310, the two waves have the same amplitude and opposite phases respectively. Thus, the two waves are not coupled at input optical waveguide 303 and the TM mode light is not output from input port 307.

The TE mode light entering output port 308 propagates in the reverse direction and is decomposed into two waves of the same amplitude and the same phase by three-branch optical coupler 311. As the two waves propagate through the interferometer, the phase difference between two waves at reciprocal phase shifter 314 of optical waveguide 305 and optical waveguide 306 is reciprocal and π. Therefore, when the two waves are coupled at three-branch optical coupler 310, the two waves have the same amplitude and opposite phases respectively. Thus, the two waves are not coupled at input optical waveguide 303 and the TE mode light is not output from input port 307. In the state where the output of a semiconductor laser is connected to input port 307 of the optical isolator, the above-described operational principle prevents the returned light from another optical device from returning to the semiconductor laser.

The above-described optical isolator, however, has the following problems. Conventional optical isolator 300 can operate only for light in a certain specific state of polarization. For example, the TE mode light entering input port 307 of TM mode optical isolator 300 propagates in the forward direction and is decomposed into two waves of the same amplitude and the same phase at three-branch optical coupler 310. As the two waves propagate through the interferometer, the phase difference between the two waves at reciprocal phase shifter 314 of optical waveguide 305 and optical waveguide 306 is reciprocal and π. Therefore, when the two waves are coupled at three-branch optical coupler 311, the two waves have the same amplitude and opposite phases respectively. Thus, the two waves are not coupled at output optical waveguide 304 and the TE mode light is not output from output port 308.

Since conventional optical isolator 300 thus uses the photomagnetic effect of nonreciprocal phase shifters 312, the isolator has the polarization dependency for the light entering input port 307. Therefore, of the light entering input port 307, the light other than the one in a specific state of polarization is removed by optical isolator 300. In other words, optical isolator 300 has the problem that it can operate for only the light in a specific state of polarization.

Further, the conventional optical isolator requires nonreciprocal phase shifter 312, reciprocal phase shifter 314 and two three-branch optical couplers 310, 311, and nonreciprocal phase shifter 312 requires a magnetic material and external magnetic field 313. As seen from the above, there is the problem that the optical isolator is structurally complicated and there is also the problem that the optical isolator has a large size since a region for disposing a magnet is required.

### SUMMARY OF THE INVENTION

The present invention has been made for solving the above-described problems. An object of the invention is to provide an optical isolator that can operate for an input light in any state of polarization and that can remove a returned light in any state of polarization without allowing the light to return to an input portion.

An optical isolator according to the present invention includes a substrate having a main surface, a plurality of optical waveguides, an input portion where light is input, an output portion where the light is output, and an oscillation generating portion. The plurality of optical waveguides are formed on the main surface of the substrate for propagating light, the optical waveguides each having a predetermined width, a first end surface and a second end surface, extending in a first direction from the first end surface to the second end surface and spaced apart from each other in a second direction orthogonal to the first direction. The input portion where light is input is formed at the first end surface of at least a first optical waveguide of the plurality of optical waveguides. The output portion where light is output is formed at the second end surface of at least a second optical waveguide different from the first optical waveguide of the plurality of optical waveguides. The oscillation generating portion generates optical Bloch oscillations of the light propagating through the optical waveguides by changing an equivalent refractive index in the second direction.

In the above-described structure, the light is input to the input portion and propagates through the optical waveguides. While optical Bloch oscillations of the light is generated, the light propagates through the optical waveguides. The amplitude of the optical Bloch oscillations does not substantially depend on the state of polarization of the input light. Thus, the optical isolator can operate for an input light in any state of polarization. Even in the case where the light input to the input portion and then output from the output portion is returned to enter the output portion, the optical Bloch oscillations of the light propagating through the optical waveguides is generated by the oscillation generating unit to prevent the returned light from entering a light emitting device such as semiconductor laser device which is connected to the input portion. In this way, a returned light in any state of polarization that enters the output portion can be removed.

Preferably, a distance over which the light that is input to the input portion travels to the output portion is set to a distance over which the light travels while a phase of the optical Bloch oscillations generated because of the equivalent refractive index changes from 0 to π.

Thus, even in the case where the light input to the input portion and output from the output portion is returned to enter the output portion, the returned light is prevented from propagating to the input portion. Namely, the optical isolator can remove the returned light.

Still preferably, the oscillation generating portion includes the plurality of optical waveguides having the width different from each other.

Thus, in the direction in which a plurality of optical waveguides are formed with a spacing therebetween, a gradient of the distribution of the equivalent refractive index of the optical waveguides is formed. Accordingly, the optical Bloch oscillations of the input light propagating through these optical waveguides can be generated.

Further, preferably the oscillation generating portion includes a heating portion disposed on one end in the second direction of the substrate for applying heat from the one end to the substrate.

Thus, the temperature of the heating unit is changed to control the gradient of the distribution of the equivalent refractive index of the optical waveguides and thereby adjust the amplitude of the optical Bloch oscillations of the input light. Therefore, without changing the position of the input portion of the optical isolator, the position of the output portion can be selected freely. Here, the amplitude of the optical Bloch oscillations refers to the distance over which the input light travels in the direction in which a plurality of optical waveguides are formed with a spacing therebetween while the phase of the optical Bloch oscillations of the input light changes from 0 to π.

Further, preferably the plurality of optical waveguides have the width identical to each other, and the oscillation generating portion includes a heating portion disposed on one end in the second direction of the substrate for applying heat from the one end to the substrate.

Thus, the temperature of the heating portion is changed to control the gradient of the distribution of the equivalent refractive index of the optical waveguides and thereby adjust the amplitude of the optical Bloch oscillations of the input light. Therefore, without changing the position of the input portion of the optical isolator, the position of the output portion can be selected freely.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view of an optical isolator according to a first embodiment of the present invention.

FIG. 2 is a cross section along a cross-sectional line II-II shown in FIG. 1 in the present embodiment.

FIG. 3 is a partially enlarged plan view of the optical isolator in the present embodiment.

FIG. 4 is a perspective view of an OBO planar waveguide device, illustrating the principle of optical Bloch oscillations in the present embodiment.

FIG. 5 is a plan view illustrating an operation of the optical isolator in the present embodiment.

FIG. 6 is a graph showing a relation between a propagation constant in the X-axis direction of an input light and a propagation constant in the Y-axis direction thereof illustrating the operation of the optical isolator in the present embodiment.

FIG. 7 is a perspective view showing a configuration where a semiconductor laser is connected to the optical isolator in the present embodiment.

FIG. 8 is a plan view of an optical isolator according to a second embodiment of the present invention.

FIG. 9 is a cross section along a cross-sectional line IX-IX shown in FIG. 8 in the present embodiment.

FIG. 10 is a partially enlarged plan view of the optical isolator in the present embodiment.

FIG. 11 is a plan view illustrating an operation of the optical isolator in the present embodiment.

FIG. 12 is a plan view of an optical isolator according to a third embodiment of the present invention.

FIG. 13 is a cross section along a cross-sectional line XIII-XIII shown in FIG. 12 in the present embodiment.

FIG. 14 is a plan view illustrating an operation of the optical isolator in the present embodiment.

FIG. 15 is a plan view of a conventional optical isolator.

FIG. 16 is a cross section of the optical isolator shown in FIG. 15.

### DESCRIPTION OF THE PREFERRED EMBODIMENTS

### First Embodiment

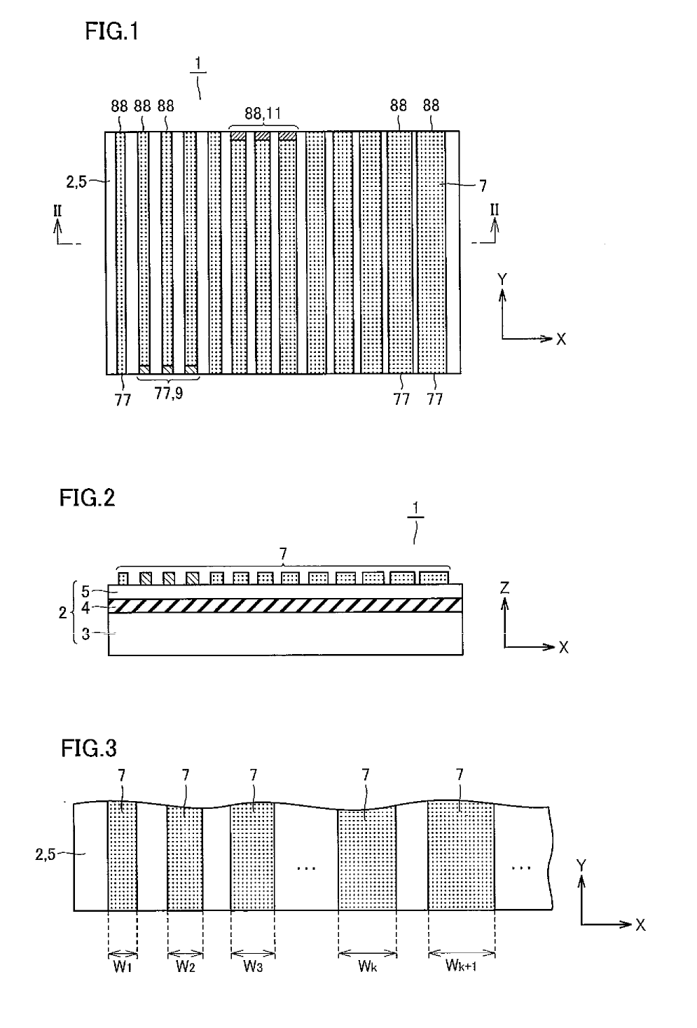

An optical isolator according to a first embodiment of the present invention will be described. The optical isolator uses, as its substrate, an SOT (Silicon On Insulator) substrate where silicon oxide (SiO₂) and silicon (Si) are deposited successively on an Si substrate. Specifically, as shown in FIGS. 1 and 2, a substrate 2 is used including an Si substrate 3, an SiO₂ layer 4 having a thickness of approximately 1 μm and deposited on Si substrate 3 and an Si layer 5 deposited further on SiO₂ layer 4. On a surface of Si layer 5 of substrate 2, a plurality of optical waveguides 7 made of silicon and having respective shapes different from each other are formed. Regarding FIGS. 1 and 2, it is supposed that the direction in which a plurality of optical waveguides 7 are disposed with a spacing therebetween is X-axis direction, the direction in which optical waveguides 7 extend is Y-axis direction and the direction perpendicular to the X-axis direction and perpendicular to the Y-axis direction is Z-axis direction.

A plurality of optical waveguides 7 each have an end surface 77 on one end in the Y-axis direction and an end surface 88 on the other end in the Y-axis direction, and these surfaces are flat. At least one end surface 77 of those end surfaces 77 on one end is an input port 9 where the light emitted from a semiconductor laser for example enters. At least one end surface 88 of those end surfaces 88 on the other end that is an end surface where the light entering from input port 9 can be output and that is any except for the end surface of optical waveguide 7 where input port 9 is located is an output port 11. Here, the positive direction of the Y axis is the direction from input port 9 toward output port 11.

Characteristics of optical isolator 1 will be described in detail. As shown in FIGS. 1 and 3, a plurality of optical waveguides 7 each extend linearly in the Y-axis direction and are separated from each other by a predetermined spacing in the X-axis direction. In particular, as shown in FIG. 3, a dimension W (width) in the X-axis direction of those optical waveguides 105 is defined such that the dimension monotonously increases in the positive direction of the X axis. In other words, respective widths (W) of the optical waveguides have the relation W₁<W₂<W₃< . . . <Wₖ<Wₖ₊₁< . . . . Regarding this optical isolator 1, the center-to-center distance in the X-axis direction between the optical waveguides is 1 μm (the distance is constant), W₁ is 0.5 μm, and the width monotonously increases in the X-axis direction so that an amount of change of the equivalent refractive index of the optical waveguides per unit length is constant in the X-axis direction.

Here, the equivalent refractive index is defined as a numerical value determined by dividing the propagation constant of the light propagating through the optical waveguides by the wave number of the light in a vacuum. For this optical isolator 1, the substantial refractive index of the light in the case where the light enters such that the peak of the intensity is at the center in the width direction of the optical waveguide is calculated. In addition to optical waveguides 7 themselves, influences of the air which is present above optical waveguides 7 as well as the Si layer located under optical waveguides 7 are considered.

As described hereinlater, as long as optical Bloch oscillations are generated and the position of an input port 9a and the position of an end surface 77 where a returned light is output are different as shown in FIG. 5, the center-to-center distance between the optical waveguides and width W₁ are not limited to the above-described numerical values. Further, width W is not limited to the value satisfying the condition that the width monotonously increases in the X-axis direction.

In optical isolator 1, optical Bloch oscillations (hereinafter abbreviated as OBO) of the light propagating through optical waveguides 7 are generated. Accordingly, from an end surface 77 of optical waveguide 7 where input port 9a is located, light is propagated toward an end surface 88 of optical waveguide 7 which is different from optical waveguide 7 where this end surface 77 is located.

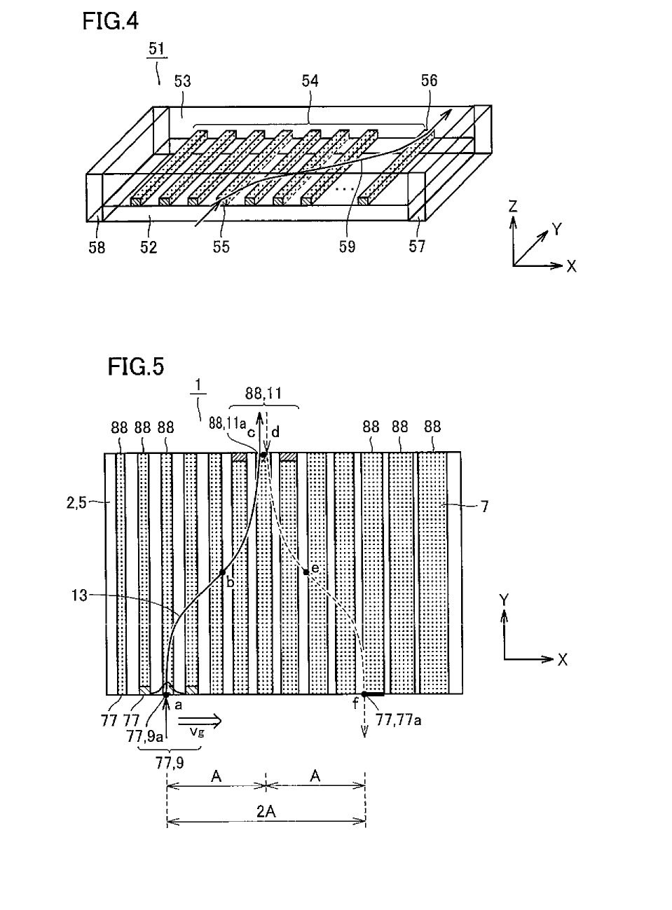

The principle of the OBO will be described using as an example a planar waveguide using the OBO (OBO planar waveguide device). As shown in FIG. 4, an OBO planar waveguide device 51 includes a substrate 52 of SiO₂ (silicon oxide) and glass and a plurality of optical waveguides 54 of a polymeric material formed on a surface of substrate 52. An input port 55 where light is input to optical waveguides 54 and an output port 56 where the light is output from optical waveguides 54 are provided. A polymer cladding layer 53 is formed on substrate 52 to cover optical waveguides 54. Polymer cladding layer 53 has the function of preventing the propagating light from leaking from optical waveguides 54. Further, a heater 57 and a heat sink 58 are provided for controlling the gradient of the temperature distribution of substrate 52.

In OBO planer waveguide device 51, an optical path of the light propagating through a plurality of optical waveguides 54 while oscillating in the X-axis direction because of the OBO is shown as a path (optical path) 59. Here, it is supposed that the direction in which a plurality of optical waveguides 54 are arranged with a spacing therebetween is X-axis direction, the direction in which each optical waveguide 54 extends is Y-axis direction and the direction perpendicular to the X-axis direction and perpendicular to the Y-axis direction is Z-axis direction.

In this OBO planar waveguide device 51, heater 57 is used to generate a gradient of the temperature distribution in the X-axis direction of substrate 52 (gradient: temperature difference per unit length). Regarding OBO planer waveguide device 51 having optical waveguides 54 made of a polymeric material, optical waveguide 54 in a region where the temperature of substrate 52 is high has an equivalent refractive index lower than that of optical waveguide 54 in a region where the temperature of substrate 52 is low. Therefore, according to the gradient of the temperature distribution, the value of the equivalent refractive index of optical waveguides 54 gradually changes in the X-axis direction. In other words, a difference is given between respective values of the equivalent refractive index per unit length in the X-axis direction.

To planer waveguide device 51, a predetermined light is input such that the peak of the intensity is present at a specific input port 55. Accordingly, the light leaks from optical waveguide 54 having input port 55 and couples to an adjacent optical waveguide 54. Consequently, the light oscillates in the X-axis direction while traveling in the Y-axis direction. This phenomenon of oscillations is called OBO. Thus, while the phenomenon of oscillations called OBO of the light is generated, a path of the light (optical path) 59 is formed through OBO planar waveguide device 51.

Such an OBO planer waveguide device is disclosed for example in the paper T. Pertsch, P. Dannberg, W. Elflein, and A. Brauer, “Optical Bloch Oscillations in Temperature Tuned Waveguide Arrays”, Physical Review letters, Vol. 83, No. 23, 4752-4755 (1999).

The OBO phenomenon of the light entering optical isolator 1 as described above will be described. As shown in FIG. 5, width W in the X-axis direction of optical waveguides 7 monotonously increases in the positive direction of the X axis. Therefore, optical waveguides 7 have a difference in equivalent refractive index per unit length in the X-axis direction, namely a gradient of the distribution of the equivalent refractive index. As the width of optical waveguide 7 is larger, the equivalent refractive index of optical waveguide 7 is higher. Thus, in the positive direction of the X axis, the equivalent refractive index of optical waveguides 7 increases. As seen from the above, a plurality of optical waveguides 7 have the function of propagating the light as well as the function as an oscillation generating unit for generating the OBO.

To optical isolator 1, a predetermined light is input such that the intensity peak is present at a predetermined input port 9a. Here, the wavelength of the light (input light) is 1.55 μm for example. Therefore, the input light leaks from optical waveguide 7 having input port 9a and couples to an adjacent optical waveguide 7 because of the OBO. Consequently, the input light oscillates in the X-axis direction (positive) while traveling in the Y-axis direction (positive). In this way, while the OBO of the input light is generated, a path of the light (optical path) 13 is formed through optical isolator 1. The amplitude of the OBO is larger as the wavelength of the light is longer. Therefore, the path (optical path) 13 of the light propagating through optical isolator 1 varies depending on the wavelength of the input light.

The OBO has the feature that the amplitude of the OBO decreases as the gradient of the distribution of the equivalent refractive index of optical waveguides 7 in the X-axis direction increases. Further, the amplitude of the OBO does not substantially depend on the state of polarization of the input light. Therefore, the input light in any state of polarization that is input to optical isolator 1 propagates through optical isolator 1 along the same path (optical path) 13. In the present embodiment, the amplitude of the OBO refers to the distance over which the input light travels in the X-axis direction while the phase of the OBO of the input light changes from 0 to π.

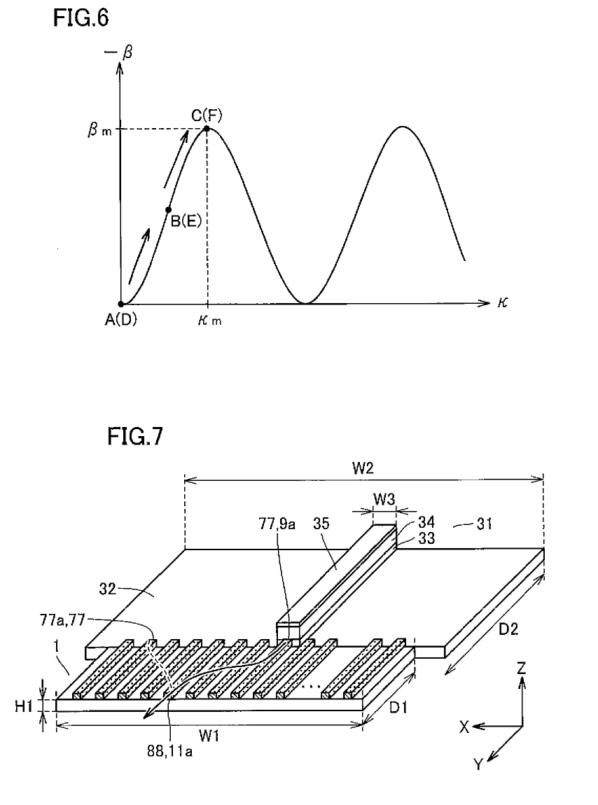

An operation (function) of above-described optical isolator 1 will be described. FIG. 6 shows a graph of a relation between a propagation constant κ of the input light in the X-axis direction and a propagation constant β of the input light in the Y-axis direction. Here, the group velocity (v_{g}) of the input light in the X-axis direction is represented as v_{g}=−∂β/∂κ. Namely, the value of v_{g} of the input light propagating through optical isolator 1 is identical to the gradient of the graph shown in FIG. 6. Further, in optical isolator 1, the positive direction of the X axis in which the equivalent refractive index of the optical waveguides increases is the positive direction of v_{g}.

As shown in FIG. 5, the input light entering input port 9a shown at point “a” of optical isolator 1 has a propagation constant κ of 0. Therefore, in FIG. 6, the state of the input light corresponds to point “A” and group velocity v_{g} of the input light at input port 9a is 0. Then, while the input light entering input port 9a propagates through optical waveguides 7 in the Y-axis direction (positive), the OBO phenomenon of the light is generated in the X-axis direction. Thus, from point “a” to point “b” (see FIG. 5), the input light travels in the X-axis direction (positive) while traveling in the Y-axis direction (positive). The state of the input light traveling from point “a” to point “b” in FIG. 5 corresponds to the state of the input light changing from point “A” to point “B” in FIG. 6.

As shown in FIG. 5, the input light then travels from point “b” to an output port 11a of optical waveguide 7 that is indicated by point “c” and the state of the input light changes from point “B” to point “C” in FIG. 6. Thus, the propagation causes the phase of the OBO from 0 to π. Namely, while the input light propagates from input port 9a of optical isolator 1 to output port 11a thereof, the phase of the OBO of the input light changes from 0 to π. Therefore, the distance in the X-axis direction between input port 9a and output port 11a of optical isolator 1 is substantially equal to the value of amplitude A of the OBO of the input light. Specifically, supposing that the x coordinate of input port 9a is 0, the x coordinate of output port 11a is +A.

The case where a returned light enters output port 11 of optical isolator 1 will be considered. An example of the returned light is, in the case where another optical device is connected to output port 11 of optical isolator 1, the light emitting from output port 11, propagating through the optical device and then reflected to return to the output port of the optical isolator.

As shown in FIG. 5, the returned light (indicated by the dotted line with an arrowhead) that enters output port 11a located at point “d” of optical isolator 1 has a propagation constant κ of 0. Therefore, in FIG. 6, the state of the returned light corresponds to point “D” and group velocity v_{g} of the returned light at output port 11a is 0. Then, while the returned light which propagates through optical waveguides 7 having the gradient of the distribution of the equivalent refractive index travels in the Y-axis direction (negative), the OBO phenomenon of the light is generated in the X-axis direction. Thus, while the returned light travels in the Y-axis direction (negative), the returned light travels in the X-axis direction (positive), from point “d” to point “e” (see FIG. 5). The state of the returned light traveling from point “d” to point “e” in FIG. 5 corresponds to the state of the returned light changing from point “D” to point “E” in FIG. 6.

In FIG. 5, the returned light travels from point “e” to an end surface 77a of optical waveguide 7 indicated by point “f”. Then, in FIG. 6, the state of the returned light changes from point “E” to point “F” and the phase of the OBO of the returned light changes from 0 to π because of the propagation. Thus, the distance between output port 11a of optical isolator 1 and end surface 77a of the optical waveguide where the returned light is output is, in the X-axis direction, a value substantially equal to amplitude A of the OBO of the returned light. Namely, supposing that the x coordinate of output port 11a is 0, the x coordinate of end surface 77a of optical waveguide 7 where the returned light is output is +A. Therefore, the position of end surface 77a of optical waveguide 7 where the returned light is output is located at a position displaced by distance 2A from the position of input port 9a in the X-axis direction (positive).

Thus, as shown in FIG. 7, in the case where a semiconductor laser device 31 is connected to input port 9a, the returned light entering output port 11a propagates to end surface 77a of optical waveguide 7 (the dotted line indicates the optical path), and the returned light does not enter semiconductor laser device 31. In other words, the returned light is removed by optical isolator 1.

As shown in FIG. 7, semiconductor laser device 31 includes a cladding layer 32, an active layer 33 formed on cladding layer 32, and a cladding layer 34 further formed on active layer 33. On cladding layer 34, an electrode 35 is formed. Cladding layer 32 has a dimension D2 of approximately 400 μm and a dimension W2 of approximately 300 μm. Active layer 33, cladding layer 34 and electrode 35 have a dimension W3 of approximately 2 to 5 μm. Optical isolator 1 has a dimension W1 of 100 μm, a dimension D1 of 250 μm and a dimension H1 of 100 μm. However, if semiconductor laser device 31 and optical isolator 1 function separately, respective dimensions of D2, W2, W3, W1, D1, and H1 are not limited to the above-described numerical values. Here, dimension H1 as shown is significantly smaller than the actual one for convenience of illustration in the drawing.

Regarding optical isolator 1 as described above, even if the light that is input to input port 9a and output from output port 11a is returned to enter the output port, the returned light will not enter semiconductor laser device 31 since the OBO of the light propagating through optical waveguides 7 is generated. Consequently, the returned light can be removed by optical isolator 1.

Moreover, optical isolator 1 as described above does not require a nonreciprocal phase shifter, an external magnetic field and a reciprocal phase shifter. Moreover, since optical isolator 1 does not use the photomagnetic effect, the isolator does not have the polarization dependency for the light entering input port 9a. Thus, optical isolator 1 can operate for an input light in any state of polarization. Further, optical isolator 1 can remove a returned light in any state of polarization. In addition, the structure of optical isolator 1 can be further simplified and downsized.

Optical isolator 1 has been described using an example where the center-to-center distance between the optical waveguides in the X-axis direction is 1 μm, W₁ is 0.5 μm and the width monotonously increases in the X-axis direction such that an amount of change of the equivalent refractive index of the optical waveguides per unit length in the X-axis direction is constant. Regarding the optical isolator, as long as the optical Bloch oscillations are generated and the position of input port 9a and the position of end surface 7a where the returned light is output are different, the center-to-center distance between the optical waveguides and width W₁ are not limited to the above-described numerical values. Further, the value of width W is not limited to the one satisfying the condition that the value of width W monotonously increases in the X-axis direction.

Further, optical isolator 1 has been described regarding the case where SiO₂ layer 4 is used as a layer of low refractive index and Si layer 5 is used as a layer of high refractive index. However, as long as the two layers that are an upper layer and a lower layer formed on silicon substrate 3 are such that a material for the upper layer has a higher refractive index than that of a material for the lower layer, Al₂O₃, InP or AlGaAs for example may be used for the layer of low refractive index and InGaAsP, GaAs, AlGas, or InP for example may be used for the layer of high refractive index. In addition, the description above relates to the case where Si is used as a material for the optical waveguides. However, as long as the material is the one where the light can propagate, such a material as InGaAsP, GaAs, AlGaAs, or InP may be used.

### Second Embodiment

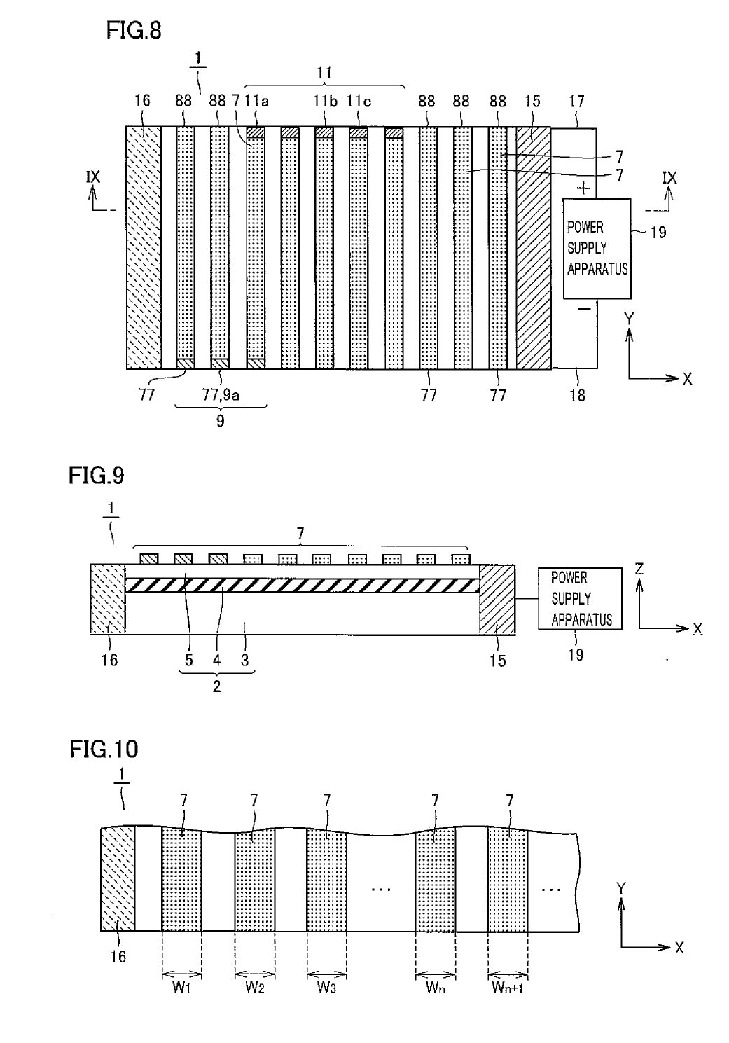

An optical isolator according to a second embodiment will be described. Regarding this optical isolator, the width of optical waveguides is constant and a heater for heating a substrate and a heat sink are provided. As shown in FIGS. 8 and 9, a plurality of optical waveguides 7 formed on a surface of an Si layer 5 of a substrate 2 extend linearly in the Y-axis direction and formed with a predetermined spacing therebetween in the X-axis direction.

Further, as shown in FIG. 10, respective dimensions W (width) in the X-axis direction of a plurality of optical waveguides 7 are set identical to each other. Specifically, respective widths (W) of the optical waveguides have the relation W₁=W₂=W₃= . . . =Wₖ=Wₖ₊₁= . . . . In this optical isolator 1, the center-to-center distance between the optical waveguides in the X-axis direction is 1 μm (constant) and respective widths W are all 0.5 μm. As long as the OBO phenomenon is generated, the center-to-center distance and the width of the optical waveguides are not limited to the above-described numerical values.

In this optical isolator 1, a heater 15 is disposed on one end surface in the X-axis direction of substrate 2 and a heat sink 16 is disposed on the other end surface. Heater 15 is electrically connected to a power supply apparatus 19 by metal wires 17, 18. Metal wire 17 connects one end in the Y-axis direction of heater 15 and the positive pole of power supply apparatus 19. Metal wire 18 connects the other end in the Y-axis direction and the negative pole of power supply apparatus 19. Here, other components and characteristics of the structure are similar to those of the structure of optical isolator 1 described above. Therefore, like components are denoted by like reference characters and the description thereof will not be repeated.

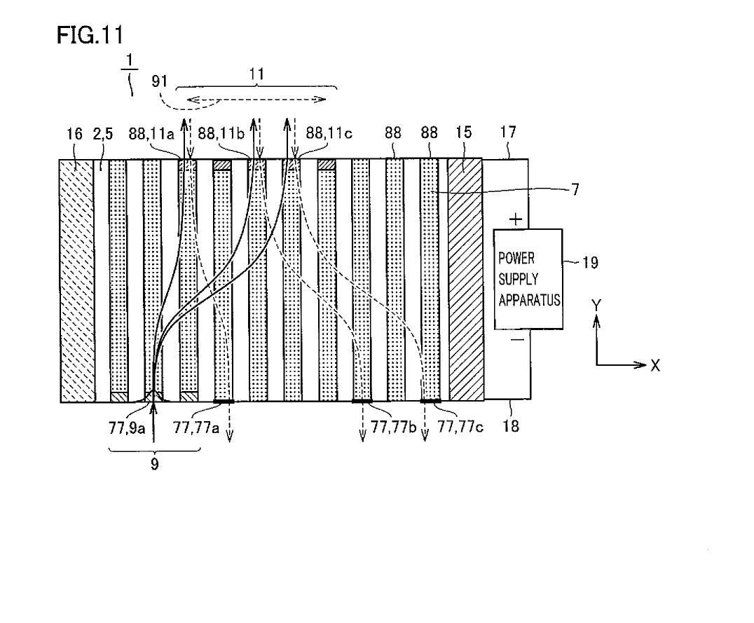

The OBO phenomenon of the light entering above-described optical isolator 1 will be described based on FIG. 11. Since heater 15 is disposed on one end surface in the X-axis direction of substrate 2 and heat sink 16 is disposed on the other end surface, the temperature distribution in the X-axis direction of substrate 2 has a gradient. Here, the temperature of substrate 2 is higher as the distance from heater 15 is shorter. Namely, the temperature of substrate 2 gradually increases in the X-axis direction (positive).

Generally, the semiconductor material has the property that its refractive index becomes higher as the temperature becomes higher. Therefore, the equivalent refractive index of optical waveguide 7 located closer to heater 15 is higher than the equivalent refractive index of optical waveguide 7 located closer to heat sink 16, and accordingly the distribution of the equivalent refractive index has a gradient in the X-axis direction. Thus, because of the gradient of the distribution of the equivalent refractive index, the phenomenon of the OBO of the input light propagating through a plurality of optical waveguides 7 is generated in the X-axis direction. As seen from the above, heater 15 that is a heating unit functions as an OBO generating unit.

Regarding optical isolator 1, the setting conditions for heater 15 and heat sink 16 are changed to change the gradient of the temperature distribution in the X-axis direction of substrate 2. Thus, the difference in equivalent refractive index per unit length of optical waveguides 7 in the X-axis direction is controlled and the amplitude of the OBO of the input light is adjusted. An example of the actual temperatures is such that the temperature of heater 15 is for example 20° and the temperature of heat sink 16 is 0°.

An operation (function) of above-described optical isolator 1 will be described. As shown in FIG. 11, a predetermined light is input to optical isolator 1 such that the peak of the intensity is present at a predetermined input port 9a. The input light entering input port 9a travels in the X-axis direction (positive) while traveling in the Y-axis direction (positive) because of the OBO phenomenon generated in the X-axis direction, and accordingly propagates to an output port 11a.

As described above, the distance in the X-axis direction between input port 9a and output port 11a of optical isolator 1 is substantially equal to amplitude A of the OBO of the input light. Therefore, supposing that the x coordinate of input port 9a is 0, the x coordinate of output port 11a is +A.

Regarding optical isolator 1, the setting conditions for heater 15 and heat sink 16 are changed to adjust amplitude A of the OBO of the input light (indicated by the dotted line with an arrowhead 91). For example, the temperature gradient may be made gentler than the above-described one so that the position of the output port is changed from output port 11a to an output port 11b for the same input port 9a. The temperature gradient may be made more gentler to change the position of the output port to output port 11c.

In the case where the light that is output from output port 11a of optical isolator 1 is returned to enter output port 11a, the OBO of the light propagating through optical waveguides 7 is generated. Thus, the returned light travels in the X-axis direction (positive) while traveling in the Y-axis direction (negative), and accordingly travels to an end surface 77a of optical waveguide 7. Likewise, the light returned to enter output port 11b propagates to an end surface 77b of optical waveguide 7, and the light returned to enter output port 11c propagates to an end surface 77c.

Regarding above-described optical isolator 1, the setting conditions for heater 15 and heat sink 16 are changed to control the temperature gradient, thereby adjusting amplitude A of the OBO of the input light. Thus, without changing the position of input port 9a, the position of output ports 11a-11c can be set freely.

Further, regarding above-described optical isolator 1, even in the case where the light that is input to input port 9a and is output from output ports 11a-11c is returned to enter output ports 11a-11c, the OBO of the light propagating through optical waveguides 7 is generated to prevent the returned light from entering semiconductor laser device 31. Optical isolator 1 can thus be used to remove the returned light.

Furthermore, optical isolator 1 described immediately above is similar to the former optical isolator 1 in that a nonreciprocal phase shifter, an external magnetic field and a reciprocal phase shifter are unnecessary and that the photomagnetic effect is not used. Thus, the isolator can operate for the input light in any state of polarization that enters input port 9a. Accordingly, the returned light in any state of polarization that enters output ports 11a-11c can be removed.

### Third Embodiment

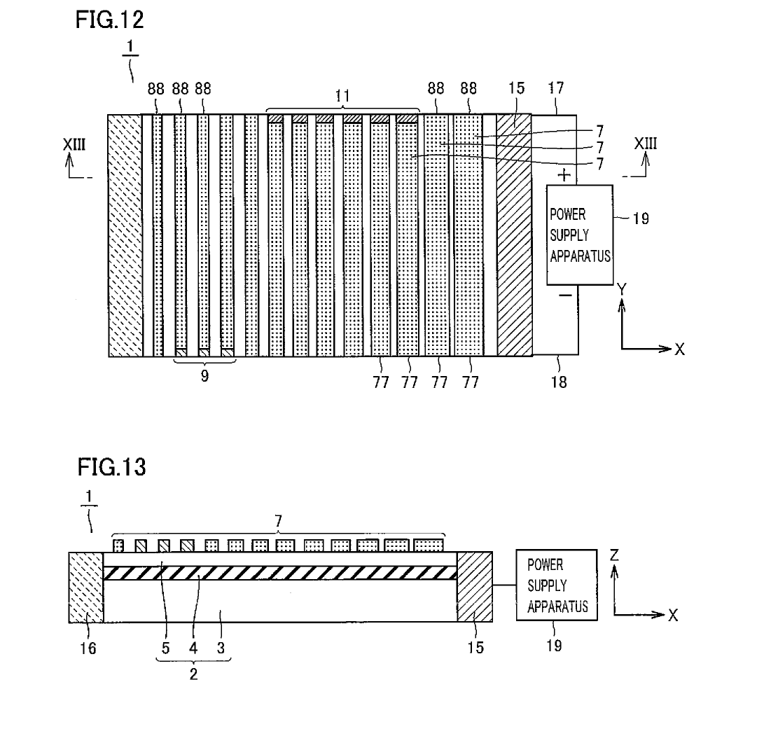

An optical isolator according to a third embodiment will be described. This optical isolator is formed such that the width of optical waveguides monotonously increases, and a heater for heating a substrate as well as a heat sink are provided. As shown in FIGS. 12 and 13, a plurality of optical waveguides 7 formed on a surface of an Si layer 5 of a substrate 2 each extend linearly in the Y-axis direction and are separated from each other by a predetermined spacing in the X-axis direction. Dimension W (width) in the X-axis direction of these optical waveguides 7 is set such that the width monotonously increases in the X-axis direction (positive).

A heater 15 is disposed on one end surface in the X-axis direction of substrate 2 and a heat sink 16 is disposed on the other end surface. Heater 15 is electrically connected by metal wires 17, 18 to a power supply apparatus 19. Other components and characteristics of the structure are similar to those of above-described optical isolator 1. Therefore, like components are denoted by like reference characters and the description thereof will not be repeated.

The OBO phenomenon of the input light entering above-described optical isolator 1 will be described. As described above, since width W in the X-axis direction of optical waveguides 7 monotonously increases in the X-axis direction (positive), the distribution of the equivalent refractive index has a gradient in the X-axis direction, and accordingly the OBO phenomenon is generated in the X-axis direction (positive). Heater 15 and heat sink 16 are used to change the gradient of the temperature distribution in the X-axis direction of substrate 2 to control the difference in equivalent refractive index per unit length of optical waveguides 7 in the X-axis direction and thereby adjust the amplitude of the OBO of the input light. Namely, the OBO is generated in optical isolator 1 because of the width of the optical waveguides (Factor A) and the temperature distribution (gradient) (Factor B). As seen from the above, a plurality of optical waveguides 7 have the function of propagating light as well as the function as an oscillation generating unit for generating the OBO. Further, heater 15 that is a heating unit also functions as an oscillating generating unit.

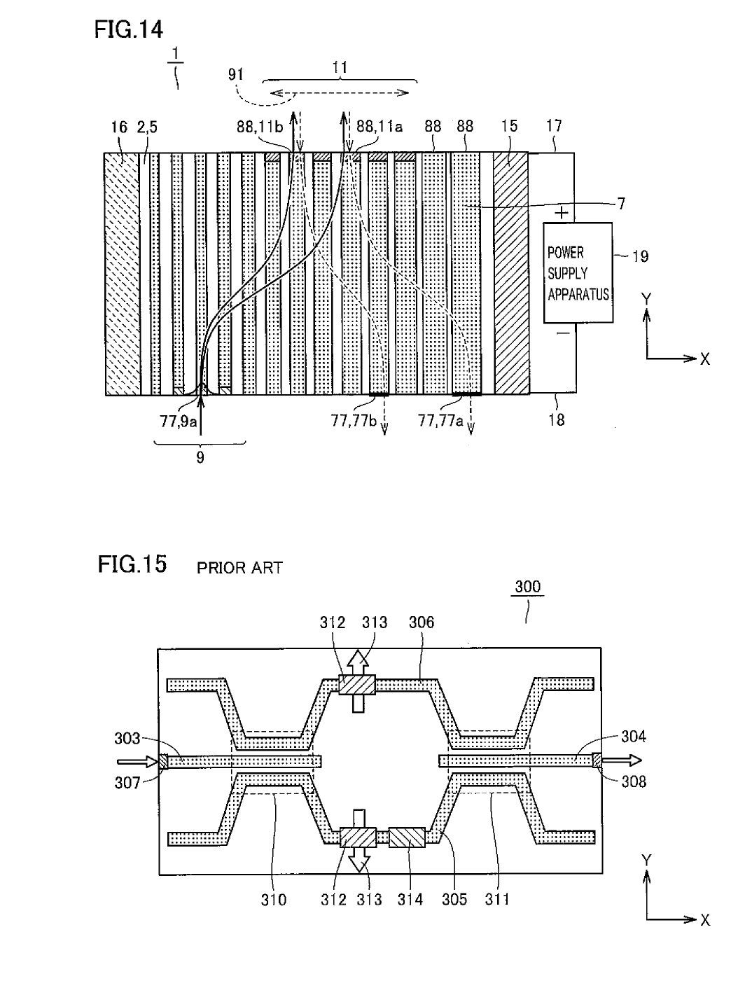

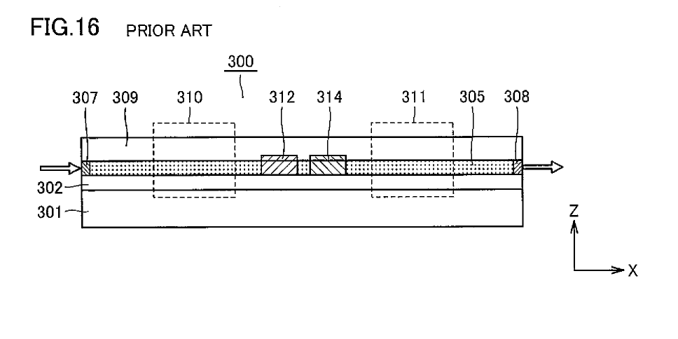

An operation (function) of above-described optical isolator 1 will be described. First, it is supposed that heater 15 is off. In this case, as shown in FIG. 14, a predetermined light is input to optical isolator 1 such that the peak of the intensity is present at a predetermined input port 9a. The OBO of the input light entering input port 9a is generated due to Factor A, and the light thus travels in the X-axis direction (positive) while traveling in the Y-axis direction (positive), and accordingly propagates to output port 11a.

In the case where the light that is output from output port 11a of optical isolator 1 is returned to enter output port 11a, the OBO of the light is generated due to Factor A, and the light thus travels in the X-axis direction (positive) while traveling in the Y-axis direction (negative), and accordingly propagates to end surface 77a of optical waveguide 7.

Next, it is supposed that heater 15 is on. In this case, as shown in FIG. 14, a predetermined light is input to optical isolator 1 such that the peak of the intensity is present at a predetermined input port 9a. The OBO of the input light entering input port 9a is generated because of Factor B in addition to Factor A. Thus, the light travels in the X-axis direction (positive) while traveling in the Y-axis direction (positive), and accordingly propagates to output port 11b.

In the case where the light that is output from output port 11b of optical isolator 1 is returned to enter output port 11b, the OBO of the light is generated because of Factor A and Factor B. The light thus travels in the X-axis direction (positive) while traveling in the Y-axis direction (negative), and accordingly propagates to end surface 77b of optical waveguide 7.

In the above-described optical isolator, the OBO is generated due to Factor A even when heater 15 is off. Therefore the power consumption can be reduced. In the case where the heater is turned on, the amplitude of the OBO of the input light can be controlled (indicated by the dotted line with an arrowhead 91) using Factor B. Thus, without changing the position of input port 9a, the position of output ports 11a, 11b can be set freely.

Further, regarding above-described optical isolator 1, even in the case where the light is input to input port 9a and then output from output ports 11a, 11b and thereafter returned to enter output ports 11a, 11b, the OBO of the light propagating through optical waveguides 7 is generated because of at least Factor A. Thus, the returned light will not enter semiconductor laser device 31. In this way, optical isolator 1 can remove the returned light.

The optical isolators each have been described using an example where the wavelength of the light that is input to the optical isolator is 1.55 μm. The wavelength of the light is not limited to this. For example, the wavelength may be those emitted from the laser diode, such as 0.4 μm to 0.48 μm, 0.63 μm to 0.68 μm, 0.78 μm to 0.98 μm, 1.3 μm to 1.67 μm.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An optical isolator comprising:
a substrate having a main surface;
a plurality of optical waveguides formed on the main surface of said substrate for propagating light, said optical waveguides each having a predetermined width, a first end surface and a second end surface, extending in a first direction from said first end surface to said second end surface and spaced apart from each other in a second direction orthogonal to said first direction;
an input portion where light is input, said input portion being formed at said first end surface of at least a first optical waveguide of said plurality of optical waveguides;
an output portion where light is output, said output portion being formed at said second end surface of at least a second optical waveguide different from said first optical waveguide of said plurality of optical waveguides; and
an oscillation generating portion for generating optical Bloch oscillations of the light propagating through said optical waveguides by changing an equivalent refractive index in said second direction.

2. The optical isolator according to claim 1, wherein
a distance over which the light that is input to said input portion travels to said output portion is set to a distance over which the light travels while a phase of said optical Bloch oscillations generated because of said equivalent refractive index changes from 0 to π.

3. The optical isolator according to claim 1, wherein
said oscillation generating portion includes said plurality of optical waveguides having said width different from each other.

4. The optical isolator according to claim 1, wherein
said oscillation generating portion includes a heating portion disposed on one end in said second direction of said substrate for applying heat from said one end to said substrate.

5. The optical isolator according to claim 1, wherein
said plurality of optical waveguides have said width identical to each other, and
said oscillation generating portion includes a heating unit disposed on one end in said second direction of said substrate for applying heat from said one end to said substrate.
